(19) United States
(12) Patent Application Publication
(10) Pub. No.: US 2023/0225353 A1
(43) Pub. Date: Jul. 20, 2023

(54) METHOD AND SYSTEM FOR MAKING A PACKAGED CONFECTIONERY PRODUCT

(71) Applicant: Sonny FONG, Pointe-Claire (CA)

(72) Inventor: Sonny FONG, Pointe-Claire (CA)

(21) Appl. No.: 17/996,377

(22) PCT Filed: Mar. 4, 2021
(86) PCT No.: PCT/CA2021/050283

§ 371 Date: Oct. 17, 2022

Related U.S. Application Data
(60) Provisional application No. 62/985,173, filed on Mar. 4, 2020.

(51) Int. Cl. A23G 3/48; A23G 3/02; B65B 25/00; B65D 75/32; B65D 75/58

(52) U.S. Cl. CPC A23G 3/48; A23G 3/0252; B65B 25/005; B65D 75/326; B65D 75/5805; B65D 2215/00

(57) ABSTRACT

A system and method for the continuous packaging of a confectionary product, such as cannabinoid confectionary products, by providing a packaging tray comprising a plurality of cavities, depositing a liquid confectionary product in each of the plurality of cavities, and overlaying a lidding material over the confectionary products to form a plurality of packaged confectionary products. The deposited confectionary product may be cooled or cured before or after overlaying the lidding material.

### FIELD OF THE INVENTION

The present invention pertains to the field of systems and methods for forming and packaging food items, and more specifically to systems and methods for forming cannabinoid confectionery products directly in their final sealed packaging.

### BACKGROUND

In known confectionery production systems and methods, the confectionery products are first formed in a mold and then must be sufficiently cooled, crystallized and/or solidified (i.e., set or cured) to facilitate removal from the mold before the final packaging steps can occur. This increases the length of the production line and time required for producing the final packaged product, resulting in higher production costs. The steps of removing the confectionery product from the mold and transferring the molded product to the final packaging cannot be carried out before the confectionery product has reached a sufficiently solidified state or the product risks being damaged during the transfer. Confectionery products may also require additional processing and handling steps after removal from the mold such as dusting with starch or powdered sugars to minimize stickiness to facilitate subsequent transfer to and storage in the final packaging materials. Conventional production systems thus place both time and quality control constraints on a producer due to concerns about product integrity during de-molding and final packaging steps.

The increased interest in confectionery products containing cannabinoids has led to the additional concern of providing packaging systems that minimize opportunities for tampering with the final packaged products, while also providing increased security against access to the packaged product by children.

Therefore there is a need for improved systems and methods that overcome the quality control and security drawbacks of prior art packaging systems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and system for making a packaged confectionery product. In accordance with an aspect of the present invention, there is provided a method of making a packaged cannabinoid confectionery product, the method comprising the steps of: providing a packaging tray having a plurality of packaging cavities formed therein; depositing a prepared liquid cannabinoid confectionery product in each of the plurality of packaging cavities to form a plurality of molded cannabinoid confectionery products; and overlaying a lidding material over the plurality of molded cannabinoid confectionery products in the packaging tray to form a plurality of packaged confectionery products.

In accordance with another aspect of the present invention, there is provided a system for the continuous preparation of packaged confectionery products, the system comprising: a tray preparation station, adapted to prepare a packaging tray having a plurality of packaging cavities formed therein; a depositor station, adapted to deposit a prepared liquid cannabinoid confectionery product in each of the plurality of packaging cavities to form a plurality of molded cannabinoid confectionery products; and a lidding station, adapted to overlay a lidding material over the plurality of molded cannabinoid confectionery products in the packaging tray to form a plurality of packaged confectionery products.

### BRIEF DESCRIPTION OF THE FIGURES

FIG. 1 illustrates a comparison of the method of the present invention with methods of the prior art.

FIG. 2 is a flowchart of a method for making a packaged confectionery product, in accordance with one embodiment of the present invention.

FIG. 3 is a flowchart of a method for making a packaged confectionery product, in accordance with one embodiment of the present invention.

FIG. 4 is a flowchart of a method for making a packaged confectionery product, in accordance with one embodiment of the present invention.

FIG. 5 is a perspective view of a packaged product prepared using a method in accordance with one embodiment of the present invention.

FIG. 6 is a perspective view of an array of cartoned products, in accordance with one embodiment of the present invention.

### DETAILED DESCRIPTION OF THE INVENTION

The term “confectionery product” is used to define food items that contain sugar or other sweetening agents. In the context of the present invention, confectionery products include chocolate-based confectionery products and gelatin-based confectionery products. The term “gelatin-based confectionery product” is used to describe generally any sweet chewable candy in which a primary ingredient is gelatin or pectin, in addition to other optional ingredients such as food sweeteners, flavorings, colorants and functional ingredients such as dietary supplements, nutrients (for example vitamins, minerals or peptides) and/or pharmaceutically active or psychoactive substances. The terms “gummy candy”, “gummies” and “jelly-type candies” are provided as non-limiting descriptors of gelatin-based confectionery products that can be produced and packaged using the processes of the present invention.

The term “chocolate-based confectionery product” is used to describe a confectionery product in which a primary ingredient is chocolate or cocoa solids, in addition to other optional ingredients such as food sweeteners, flavorings, colorants and functional ingredients such as dietary supplements, nutrients (for example vitamins, minerals or peptides) and/or pharmaceutically active or psychoactive substances.

The term “cannabinoid confectionery product” is used to define confectionery products that contain one or more cannabinoid compounds as a functional ingredient. In the context of the present invention, cannabinoid confectionery products include chocolate-based cannabinoid confectionery products and gelatin-based cannabinoid confectionery products.

The term “cannabinoid compound” refers to psychoactive compounds that are extracted from the cannabis plant, and which include, but are not limited to, tetrahydrocannabinol (THC) and cannabidiol (CBD).

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The methods of the present invention for packaging cannabinoid confectionery products are particularly suitable for packaging cannabinoid confectionery products that are in a liquid state prior to formation into the final cannabinoid confectionery product by providing a convenient way to package the cannabinoid confectionery products directly in their final package. The methods of the present invention therefore do not require a step of removing a hardened product from a mold prior to incorporation into a final packaging material since the confectionery product is formed directly in the final packaging material. This allows the product to be packaged without loss or degradation of product through unnecessary handling steps.

In one embodiment, the packaging methods of the present invention allow the step of sealing the product into its respective packaging cavity to be carried out before the confectionery product has reached its final solidified or cured state. This results in an expedited packaging process, while also minimizing handling steps.

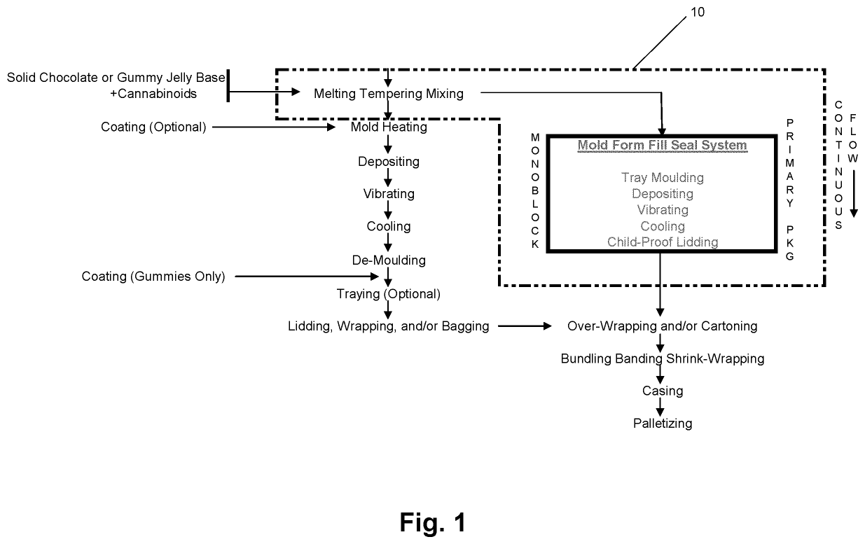

The present system can be operated in a continuous manner to provide the final packaged confectionery product without interruption between the different steps in the packaging method. FIG. 1 schematically depicts the method of the present invention depicted within the dashed line box 10, and prior art steps are shown outside the dashed line box.

In accordance with the present invention, the method of making a packaged cannabinoid confectionery product is carried out using a packaging tray suitable for receiving the liquid confectionery products. The packaging tray has a plurality of packaging cavities formed therein, and is used as both the mold for forming the confectionery product and as the final packaging material.

In accordance with the present invention, the method of making the packaged confectionery product also comprises a step of depositing a prepared liquid confectionery product in each of the plurality of packaging cavities in the packaging tray.

In the case of chocolate confectionery products, the deposited liquid confectionery product is typically a molten chocolate product, which is allowed to set in place in the packaging tray. In the case of gelatin-based confectionery products, the deposited liquid confectionery product is typically a liquid gelatin-based mixture, which is allowed to set/gel in place in the packaging tray to provide the final hardened gummy or jelly-type product.

The present methods are particularly useful for manufacturing packaged gelatin-based confectionery products such as gummies and jelly-type edible products, which by nature tend to be sticky, thus presenting particular handling and packaging challenges, typically requiring an additional step of coating the confectionery product with starch or sugars to facilitate subsequent packing steps. The methods of the present invention do not necessitate de-molding or handling of the solidified product prior to packaging, allowing elimination of the prior art step of coating the product.

Elimination of the de-molding step allows the packaging process to be carried out with only a single point of product contact from fill to package, which significantly decreases the number of product manipulation steps, and which reduces the risk of exposure to potential contaminants or product identification/labeling errors.

The elimination of the de-molding step also optimizes process efficiencies by minimizing the possible loss of or damage to the final confectionery product that can result during the additional handling steps associated with subsequent packaging of the de-molded products.

In one embodiment, the packaging tray is provided as a preformed rigid or semi-rigid tray having one or more packaging cavities. In one embodiment, the packaging tray can be formed from preformed polymeric materials.

The polymeric materials used to form the packaging tray include, but are not limited to, polyethylene (PE), polyvinylchloride (PVC), polyvinylidene chloride (PVDC), chlorotrifluoroethylene (CTFE), polychlorotrofluororethylene (PCTFE), polystyrene (PS), and polyethylene terephthalate (PET) and combinations thereof. In one embodiment, the packaging tray is formed from a film comprising a blend of polymers. In one embodiment, the packaging tray is formed from polymeric materials provided as a laminate of two or more polymeric films. In one embodiment, the packaging tray is formed from a PVDC/PE/PVC laminate film.

In one embodiment, the packaging tray can be formed from preformed metallic materials. In one embodiment, the metallic material is an aluminum based alloy material. In one embodiment, the packaging tray is formed from a laminate comprising at least one layer of a metallic material.

In one embodiment, the packaging tray is provided as a layer of packaging film overlaid on a molding tray having one or more packaging cavities, wherein the packaging film conforms to the shape of the underlying molding tray.

In one embodiment, the packaging tray is formed of a thermoplastic material through a thermoforming process in which a thermoformable packaging film is overlaid on a molding tray and having one or more packaging cavities, wherein the packaging film conforms to the shape of the underlying molding tray upon heating, and hardens to a rigid or semi-rigid packaging tray upon cooling.

Suitable thermoformable materials range from soft materials to semi-rigid materials, and include, but are not limited to, polypropylene (PP), polyethylene (PE), polyamide/polyethylene (PA/PE), polycarbonate/polyethylene (PC/PE), glycol modified polyethylene terephthalate (PET), and polyvinyl chloride (PVC).

Many different materials and material gauges (thicknesses) are available for use as packaging films. Preferred thicknesses are between about 65 micrometers and about 300 micrometers.

Once the confectionery product has been deposited in the packaging cavities, a lidding material is provided to cover the deposited confectionery to provide the packaged cannabinoid confectionery product in its final hermetically-sealed packaged state.

In one embodiment, the lidding material is laid over the plurality of molded cannabinoid confectionery products in the packaging tray to form a plurality of packaged cannabinoid confectionery products.

The material used for lidding material can have similar characteristics to the material used for the packaging film (i.e., for forming the film cavities), or the sealing films can be thinner since there is no need to thermoform the sealing film.

In one embodiment, the lidding material is formed from a foil material.

In one embodiment, the lidding material is a “push-through” seal. In such an embodiment, the confectionery product is removed from the packaging cavity by pushing the product through the lidding material.

In one embodiment, the lidding material is provided as a childproof or child resistant resistant seal.

Childproof or child resistant seals can be provided in a number of configurations. In one embodiment, the childproof seal is provided as a multilayer laminate seal that requires multiple steps to remove the the confectionery product from the packaging cavity. In one embodiment, the lidding material is provided as a laminate comprising a combination of two or more layers of polymeric material, foil and/or paper.

In one embodiment, the lidding material is a “tear-open” seal that requires the consumer to tear the lidding material at a notch to provide access to the packaged confectionery product.

In one embodiment, the lidding material is a “peel-open” seal that requires the consumer to peel off an outer layer (e.g., a PET, or PET/paper laminate) to reveal the confectionery product.

In one embodiment, the lidding material is a “peel-push” multilayer seal that requires the consumer to peel off an outer layer (e.g., a PET, or PET/paper laminate) to reveal a further layer (e.g., a foil layer) that can be broken by pushing through the confectionery product.

In one embodiment, the lidding material is a “peel-peel-push” multilayer seal that requires the consumer to sequentially peel off two outer layers to reveal a further layer (e.g., a foil layer) that can be broken by pushing through the confectionery product.

In one embodiment, the lidding material is formed from a PET/Aluminum/PET-Paper laminate film as the child resistant lidding.

In one embodiment, after the lidding material has been applied, the plurality of packaged confectionery products is cut to provide a smaller set of packaged confectionery products.

In one embodiment, after the lidding material has been applied, the plurality of packaged confectionery products is cut into individually packaged confectionery products.

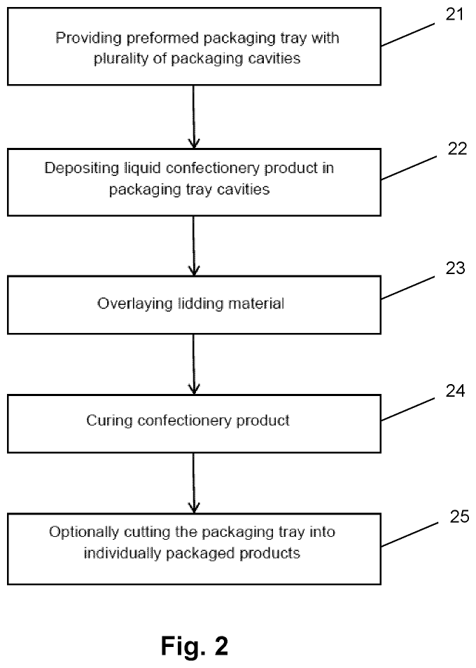

FIG. 2 is a schematic depiction of one embodiment of the packaging process of the present invention. In this embodiment, the packaging tray is provided as a preformed tray having a plurality of packaging cavities (21). The liquid confectionery product is deposited in the cavities (22) followed by overlaying of a lidding material on the packaging tray (23). The confectionery product is then allowed to cure (24), and the packaging tray is optionally cut into individual packaged products (25).

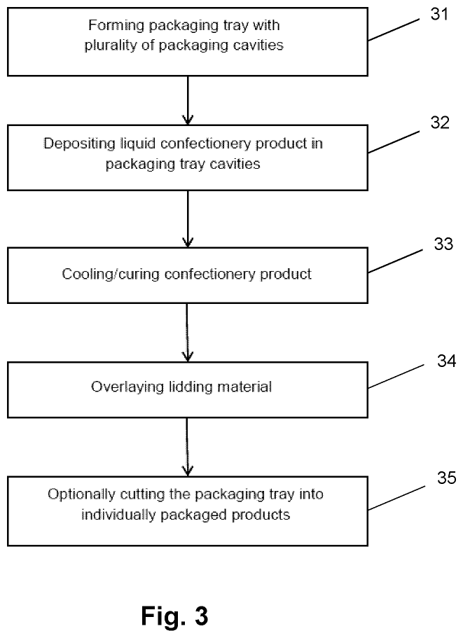

FIG. 3 is a schematic depiction of one embodiment of the packaging process of the present invention. In this embodiment, the process includes the step of forming the packaging tray having a plurality of packaging cavities (31). The liquid confectionery product is deposited in the cavities (32) followed by cooling and/or curing confectionery product (33). The lidding material is overlaid on the packaging tray (34). The packaging tray is then optionally cut into individual packaged products (35).

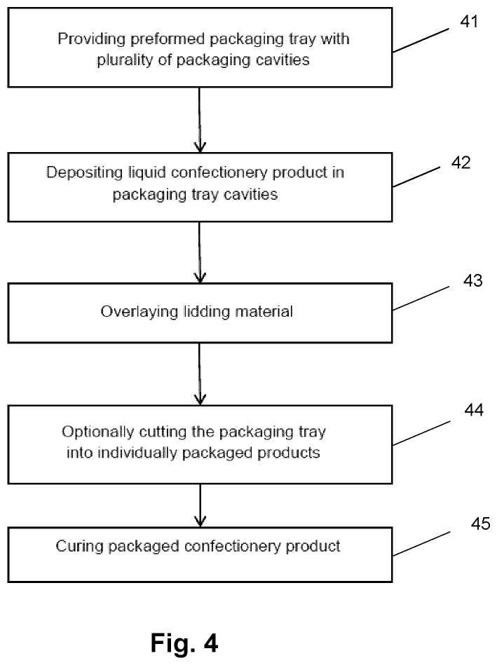

FIG. 4 is a schematic depiction of one embodiment of the packaging process of the present invention. In this embodiment, the packaging tray is provided as a preformed tray having a plurality of packaging cavities (41). The liquid confectionery product is deposited in the cavities (42) followed by overlaying of a lidding material on the packaging tray (43). The packaging tray is optionally cut into individual packaged products (44), and the individual packaged products are allowed to cure (45).

The embodiments depicted in FIGS. 2 to 4 are not intended to be limiting, and may be modified. For example, the process depicted in FIG. 3 may be modified by changing the first step to providing a preformed packaging tray. As another example of modifications that fall within the scope of the present invention, the processes depicted in FIGS. 2 and 4 may also include a cooling step before or after the lidding step.

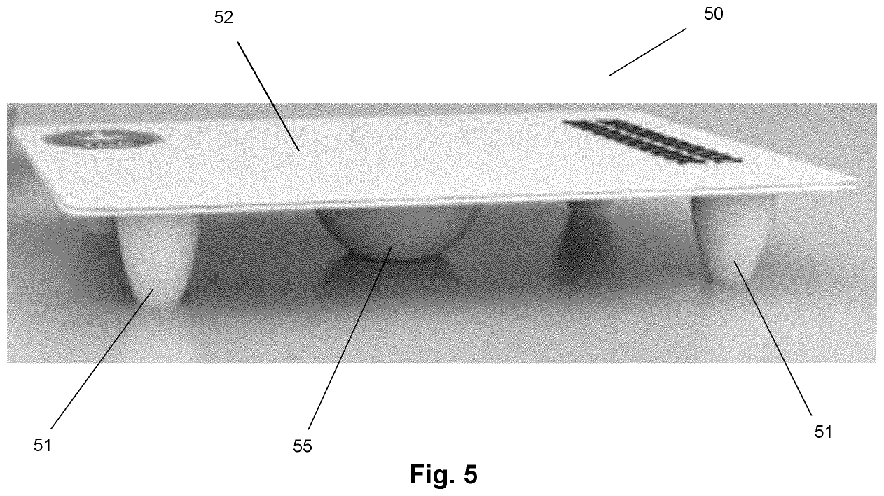

FIG. 5 depicts a single unit packaging tray 50, in accordance with one embodiment of the invention. In this embodiment, the tray includes packaging cavity 55, lidding material 52, and tray supports 51 located at each corner of the packaging tray to provide stability to the packaging tray within the carton.

The liquid confectionery product to be packaged may be prepared in accordance with preparation methods as are known in the art. For example, a chocolate-based confectionery product may be prepared by carrying out preparation steps including, but not limited to, the combining and blending of ingredients, followed by conching and/or tempering steps as required, to provide a liquid chocolate-based confectionery product. In a similar manner, a gelatin-based confectionery product may be prepared by carrying out preparation steps including, but not limited to, the combining and blending of ingredients to provide a liquid gelatin-based confectionery product.

The present invention also provides systems suitable for carrying out the methods of making the packaged confectionery products of the present invention, comprising a sequence of stations, each station being adapted to carry out one or more steps of the packaging process.

The selection and arrangement of stations in the production line is based on the particular characteristics and components of the confectionery which is being produced on the production line, and can be implemented using methods and equipment known in the art.

In one embodiment, the systems of the present invention can be adapted to manufacture and package both chocolate- and gelatin-based cannabinoid confectionery products.

The present packaging systems and processes are also adaptable to continuous-flow manufacturing processes, and can be appended in place of conventional packaging processes that are typically employed in processes and systems for producing confectionery products as are known in the art.

In one embodiment, the packaging process is carried out using a conveyor belt on which the packaging tray is carried and conveyed from station to station in the production line through the different steps of forming and packaging the cannabinoid confectionery product. In a preferred embodiment, the use of the conveyor belt facilitates the continuous nature of the packaging process.

In one embodiment, the first station in the system is a tray preparation station used to provide and prepare the packaging tray to receive the cannabinoid confectionery product.

Where the packaging tray employed in the packaging process is provided as a preformed tray, the tray preparation station may simply involve placement of the preformed packaging tray in the production line to be conveyed through the sequence of stations.

In one embodiment in which the packaging tray employed in the packaging process is formed in situ as part of the packaging process, the tray preparation station of the present invention comprises a forming station.

In one embodiment, the packaging tray is formed on a molding tray by overlaying a packaging film, unwound from a reel under tension, onto the molding tray.

In one embodiment, the molding tray comprises a plurality of vacuum holes through the one or more mold cavities of the molding tray, allowing the packaging film to be stretched and drawn into each of the mold cavities in a conforming manner, thus forming a packaging cavity within each of the mold cavities in the molding tray.

In one embodiment, the packaging film is a thermoplastic film, and the forming station is a thermoforming station in which the one or more packaging cavities are formed in a thermoplastic packaging film using a thermoforming process. In this embodiment, the molding tray is supported above or below a heater element which is provided to soften the thermoplastic film. In one embodiment, the heating element is an infrared heater. Once the thermoplastic film has been sufficiently softened by radiant heat from the heater, a vacuum is applied to evacuate air from between the film and the molding tray, thus compelling the film to conform to the molding tray through formation of a vacuum-tight seal between the film and the upper side of the molding tray.

In an alternative embodiment, pressure forming could be used instead of vacuum forming to conform the film to the molding tray.

In an embodiment of the process in which a plurality of packaging trays is formed in the production line on a series of molding trays, the packaging film is unwound from the reel and overlaid on the series of molding trays.

In one embodiment, the formed film is retained in place on the molding tray and is conveyed to the next stage in the production line on the carrier plate.

In one embodiment, the thermoplastic film is cut approximately to the size of the carrier plate(s) before the conforming step is carried out. In one embodiment, the excess thermoplastic film is cut after the conforming step has been carried out.

Once the packaging cavities have been formed, the molding tray is lowered away from the heater and the film is allowed to cool. Once the packaging cavities have been formed, the resulting packaging tray is then passed through the remaining stations of the production line to continue with preparation of the packaged confectionery product.

In one embodiment, each packaging cavity remains nested in a respective one of the mold cavities until at least after the molded confectionery product has been prepared.

In one embodiment, the molding tray is carried on a movable carrier plate. In such an embodiment, the packaging process is carried out by carrying and conveying the carrier plate from station to station in the production line through the different steps of forming and packaging the confectionery product. In a preferred embodiment, the carrier plate is conveyed on a conveyor belt.

In one embodiment, the carrier plate doubles as a molding tray on which the packaging tray is formed by overlaying a packaging film over the molding tray. In this embodiment, the packaging film is conformed to the shape of the molding cavities in the carrier plate/molding tray to form the packaging tray.

In one embodiment, the carrier plates are transported from station to station. In one embodiment, the production line is operated in a continuous manner. In one embodiment, the carrier plate is conveyed between stations on a conveyor belt. In one embodiment, the production line is operated in a non-continuous manner. A non-continuous carrier plate based production line allows for independent control at each of the stations, with the individual carrier plate used as carrying supports at every stage of the packaging process.

The system of the present invention further comprises a depositor station at which the liquid confectionery (e.g., molten chocolate or liquid gelatin mixture) is deposited into the plurality of packaging cavities.

In one embodiment, the depositor station further comprises means for agitating or vibrating the liquid cannabinoid confectionery in one or more planes as required to spread the cannabinoid confectionary in the packaging cavities and/or to remove air from the liquid cannabinoid confectionery product.

The system of the present invention further comprises a lidding station. Once the molded confectionery product has been prepared, the packaging tray is then moved to the lidding station, where a lidding material is used to seal each of the plurality of packaging cavities, thus defining the internal volume encasing and hermetically sealing the packaged cannabinoid confectionery product.

In one embodiment, the plurality of packaging cavities is sealed by attaching a lidding material at a lidding station, thereby forming a sealed, filled package that holds a plurality of molded cannabinoid confectionery products.

In one embodiment, the lidding material is a thermoplastic material and may be comprised of the same material as the packaging film.

In one embodiment, the lidding material could be thinner and/or less rigid, or thicker and/or more rigid than the packaging film used to form the packaging tray.

For those embodiments in which a thermoplastic material is employed as the lidding material, the sealing step may be carried out by applying a heating element at the contact surfaces of the packaging film and the lidding material.

In further alternate embodiments, the lidding material could be formed from non-thermoplastic material such as a laminate material, a metallic foil material, or a laminate material comprising at least one layer of a metallic foil.

For those embodiments in which a non-thermoplastic material is employed as the lidding material, the sealing step may be carried out by applying an adhesive at the contact surfaces of the packaging film and the lidding material.

In one embodiment, the lidding material is provided as a childproof seal.

In one embodiment, each packaging cavity remains nested in a respective one of the mold cavities until at least after sealing step has been performed in the sealing station.

The system of the present invention may also comprise a cooling station and/or a curing station. If necessary, the deposited product can be further cooled at the cooling station or cured at the curing station for a time sufficient to ensure that the confectionery product has solidified/gelled into a molded cannabinoid confectionery product.

In a preferred embodiment, the curing station is provided after the lidding station.

In one embodiment, the system of the present invention further comprises a cutting station.

Once the array of filled-in, sealed packaged confectionery products has been created, the array may be transferred to the cutting station. The cutting station comprises a cutter element that is configured to cut through the layers of packaging materials to provide individual or multi-packs of packaged confectionery products as desired. In one embodiment, the cutter element is a rotary cutter that functions by rolling along a cutter plate. In one embodiment, the cutter element may be a plate-style cutter or could comprise one or more anvil-style linear or grid-like cutting blades, in a configuration appropriate to the arrangement of the array of sealed packaged confectionery products.

In one embodiment, the plurality of packaged confectionery products is cut to provide a smaller set of packaged confectionery products.

In one embodiment, the plurality of packaged confectionery products is cut into individually packaged confectionery products.

In one embodiment, the system of the present invention further comprises a cartoning station. In such an embodiment, the packaged confectionery products (cut or uncut) can be transferred to a cartoning station, where they can be cartoned for end use, display, and/or transport. In one embodiment, the cartoned product may be further bundled, banded, shrink-wrapped, cased and/or palletized as required for transport or storage.

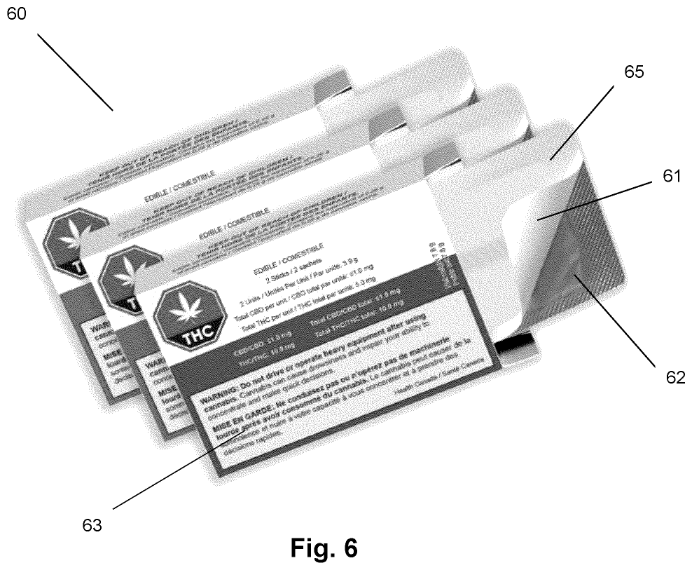

FIG. 6 shows an array of cartoned products 60, showing a packaged multi-unit product 65 partially extending out of carton 63. Also shown is the laminate lidding material, including the foil under layer 62 and the childproof over layer 61.

The invention will now be described with reference to specific examples. It will be understood that the following examples are intended to describe embodiments of the invention and are not intended to limit the invention in any way.

### EXAMPLES

### Example 1

### Chocolate Confectionery Products

For preparation of the chocolate confectionery products, the stock bulk solutions/slurries were prepared according to the recipes in Tables 1 and 2, and combined in a heated kettle fitted with a mixer. Stirring continued at 45° C. until the mixture became homogenous, at which point the heat was lowered to 32° C. Once cooled, the liquid chocolate confectionery mixture was transferred to the product depositor/packaging system for packaging.

TABLE 1
10 mg THC Belgian Chocolate Recipe

| Ingredient | Quantity |
|---|---|
| Preconched Belgium chocolate | 387.125 kg |
| Coconut oil | 1.1 kg |
| Liquid soy lecithin | 0.4 kg |
| THC Cannabis Oil | 1.385 kg |

TABLE 2
25 mg CBD Belgian Chocolate Recipe

| Ingredient | Quantity |
|---|---|
| Preconched Belgium chocolate | 383.112 kg |
| Coconut oil | 2.5 kg |
| Liquid soy lecithin | 0.950 kg |
| CBD Cannabis Oil | 3.438 kg |

The individual chocolate confectionery products were deposited in a packaging tray in 3.9 g quantities, followed by an immediate application of the lidding material, followed by an immediate cut to form to provide single unit sealed chocolate confectionery products in the shape of hemispherical cups, followed by an immediate cartoning of each single unit, followed by an immediate casing of 96 single units per case, which are then palletized. The finished packaged palletized products were then allowed to rest/cure undisturbed for approximately 12-24 hours before shipment. The packaging tray was formed from PVDC/PE/PVC laminate film and the child resistant lidding was formed from PET/Al/PET-Paper laminate film.

### Example 2

### Gummy Confectionery Products

For preparation of the gummy confectionery products, the stock bulk solutions/slurries were prepared according to the recipes in Tables 3 and 4, and combined in a heated kettle fitted with a mixer. Stirring continued at 65° C. until the mixture became homogenous, at which point the heat was lowered to 45° C. Once cooled, the liquid gummy confectionery mixture was transferred to the product depositor/packaging system for packaging.

The individual gummy confectionery products were deposited in a packaging tray in 3.9 g quantities, followed by an immediate application of the lidding material, followed by an immediate cut to form to provide single unit sealed chocolate confectionery products in the shape of hemispherical cups, followed by an immediate cartoning of each single unit, followed by an immediate casing of 96 single units per case, which are then palletized. The finished packaged palletized products were then allowed to rest/cure undisturbed for approximately 12-24 hours before shipment. The finished packaged palletized product was then allowed to rest/cure undisturbed for approximately 12-24 hours before shipment. The packaging tray was formed from PVDC/PE/PVC laminate film and the child resistant lidding was formed from PET/Al/PET-Paper laminate film

TABLE 3
10 mg THC Gummy

| Ingredient | Quantity |
|---|---|
| Gelatin | 75.0 kg |
| Sugar | 79.45 kg |
| Corn Syrup | 73.265 kg |
| Flavour | 19.931 kg |
| Dye | 0.399 kg |
| Citric Acid | 0.598 kg |
| Coconut Oil | 1.1 kg |
| Liquid Soy Lecithin | 0.4 kg |
| THC Cannabis Oil | 1.385 kg |
| Water | 138.482 kg |

TABLE 4
25 mg CBD Gummy

| Ingredient | Quantity |
|---|---|
| Gelatin | 75.0 kg |
| Sugar | 78.64 kg |
| Corn Syrup | 70.887 kg |
| Flavour | 19.828 kg |
| Dye | 0.397 kg |
| Citric Acid | 0.595 kg |
| Coconut Oil | 2.5 kg |
| Liquid Soy Lecithin | 0.95 kg |
| CBD Cannabis Oil | 3.438 kg |
| Water | 137.766 kg |

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method of making a packaged cannabinoid confectionery product, the method comprising the steps of:
providing a packaging tray having a plurality of packaging cavities formed therein;
depositing a prepared liquid cannabinoid confectionery product in each of the plurality of packaging cavities to form a plurality of molded cannabinoid confectionery products; and
overlaying a lidding material over the plurality of molded cannabinoid confectionery products in the packaging tray to form a plurality of packaged confectionery products.

2. The method of claim 1, further comprising a step of cooling the liquid cannabinoid confectionery product after depositing.

3. The method of claim 1 or 2, further comprising a step of curing the liquid cannabinoid confectionery product to form the plurality of molded cannabinoid confectionery products, wherein the cannabinoid confectionery product is allowed to cure after the step of overlaying the lidding material.

4. The method of claim 1 or 2, further comprising a step of curing the liquid cannabinoid confectionery product to form the plurality of molded cannabinoid confectionery products, wherein the cannabinoid confectionery product is allowed to cure prior to the step of overlaying the lidding material.

5. The method of any one of claims 1 to 4, wherein the cannabinoid confectionery product is a gelatin-based confectionery product.

6. The method of any one of claims 1 to 4, wherein the cannabinoid confectionery product is a chocolate-based confectionery product.

7. The method of any one of claims 1 to 6, wherein the packaging tray is a preformed tray.

8. The method of any one of claims 1 to 6, wherein the packaging tray is formed by overlaying a packaging film over a molding tray having a plurality of molding cavities formed therein, and conforming the packaging film to the shape of the molding cavities.

9. The method of claim 8, wherein the packaging film is a thermoplastic film.

10. The method of claim 8, wherein the packaging film comprises polypropylene (PP), polyethylene (PE), polyamide/polyethylene (PA/PE), polycarbonate/polyethylene (PC/PE), glycol modified polyethylene terephthalate (PETg), polyvinylidene chloride (PVDC), chlorotrifluoroethylene (CTFE), polychlorotrofluororethylene (PCTFE), polystyrene (PS), or polyvinyl chloride (PVC).

11. The method of any one of claims 1 to 10, wherein the lidding material provides a child proof lidding.

12. The method of any one of claims 1 to 10, wherein the lidding material is formed from a foil material.

13. The method of any one of claims 1 to 10, wherein the lidding material is formed from a polymeric material.

14. The method of claim any one of claims 1 to 13, further comprising the step of cutting the plurality of packaged cannabinoid confectionery products into a smaller set of packaged confectionery products.

15. The method of any one of claims 1 to 13, further comprising the step of cutting the plurality of packaged confectionery products into a plurality of individually packaged cannabinoid confectionery products.

16. The method of any one of claims 1 to 15, wherein the packaged cannabinoid confectionery product is a hermetically sealed packaged cannabinoid confectionary product.

17. A system for the continuous preparation of packaged cannabinoid confectionery products, the system comprising:
a tray preparation station, adapted to prepare a packaging tray having a plurality of packaging cavities formed therein;
a depositor station, adapted to deposit a prepared liquid cannabinoid confectionery product in each of the plurality of packaging cavities to form a plurality of molded cannabinoid confectionery products; and
a lidding station, adapted to overlay a lidding material over the plurality of molded cannabinoid confectionery products in the packaging tray to form a plurality of packaged confectionery products.

18. The system of claim 17, wherein the cannabinoid confectionery product is a gelatin-based confectionery product.

19. The system of claim 17, wherein the cannabinoid confectionery product is a chocolate-based confectionery product.

20. The system of any one of claims 17 to 19, further comprising a cooling station.

21. The system of any one of claims 17 to 20, wherein the tray preparation station is adapted to prepare the packaging tray by overlaying a packaging film over a molding tray having a plurality of molding cavities formed therein, and conforming the packaging film to the shape of the molding cavities.

22. The system of any one of claims 17 to 20, wherein the tray preparation station is a thermoforming station.

23. The system of any one of claims 17 to 22, further comprising a cutting station, adapted to cut the plurality of packaged confectionery products into a plurality of individually packaged cannabinoid confectionery products.

24. The system of any one of claims 17 to 23, further comprising a cartoning station, adapted to place the plurality of packaged confectionery products into cartons.

25. The system of any one of claims 17 to 24, further comprising a curing station, adapted to cure the liquid cannabinoid confectionery product to form the plurality of molded cannabinoid confectionery products.

26. The system of claim 25, wherein the curing station is provided after the lidding station.

27. The system of claim 25, wherein the curing station is provided after the cartoning station.
